(19) United States
(12) Patent Application Publication
(10) Pub. No.: US 2021/0008938 A1
(43) Pub. Date: Jan. 14, 2021

(54) TONGUE JACK CHAIN AND CORD HOLDER

(71) Applicant: Lippert Components, Inc., Elkhart, IN (US)

(72) Inventors: Barry Wade Ousley, Syracuse, IN (US); Steve Paul, Granger, IN (US); Mark Boessler, Elkhart, IN (US)

(21) Appl. No.: 16/924,724

(22) Filed: Jul. 9, 2020

Related U.S. Application Data
(60) Provisional application No. 62/872,867, filed on Jul. 11, 2019.

(51) Int. Cl. B60D 1/66

(52) U.S. Cl. CPC B60D 1/66

(57) ABSTRACT

A tongue jack includes a tongue jack head and an accessory hook coupled with the tongue jack head. The accessory hook is suited for supporting chains and electrical cords typically associated with the connection between a trailer and a tow vehicle.

### CROSS-REFERENCES TO RELATED APPLICATIONS

This application claims the benefit of U.S. Provisional Patent Application No. 62/872,867, filed Jul. 11, 2019, the entire content of which is herein incorporated by reference.

### STATEMENT REGARDING FEDERALLY SPONSORED RESEARCH OR DEVELOPMENT

(Not Applicable)

### BACKGROUND

A tongue jack for supporting the tongue of a trailer typically includes a telescoping assembly having an inner tube received within an outer tube and an operating mechanism for extending and retracting the inner tube from and to the outer tube. A jack plate typically is attached to the outer tube. The tongue jack inner tube may be provided with a support foot or the like.

A trailer coupler typically includes a hitch ball-receiving portion and a frame-receiving portion configured for connection to a trailer frame. The frame-receiving portion typically includes a top plate defining a tube-receiving hole configured to receive the outer tube of the jack.

In use, the tongue jack serves to raise and lower the support foot and thereby raise and lower the trailer and the hitch ball-receiving portion to facilitate connecting the trailer to and disconnecting the trailer from a tow vehicle hitch ball. The tongue jack also serves to support the trailer when the trailer is disconnected from the tow vehicle.

Various chains and electrical cords are typically associated with the connection between a trailer and a tow vehicle. Towing accessories are sometimes added to the trailer frame, towing hitch frame, or tongue jack to help contain and organize the chains and electrical cords. These accessories can be obstructive or cumbersome for the user to work around when the accessories are not in use, or they may need to be removed when not needed. Towing accessories associated with the tongue jack are typically mounted to the support pole or shaft extending between a head and foot of the tongue jack. It would be desirable to integrate features into the tongue jack head for storage and organization of the chains and cords.

### BRIEF SUMMARY

A tongue jack includes a tongue jack head housing operating components. The operating components serve to drive a telescoping lifting foot between an extended position and a retracted position to lift and lower a trailer and a hitch ball-receiving component relative to the ground. An accessory hook is coupled with the tongue jack head that is suited for supporting associated chains and electrical cords.

In an exemplary embodiment, a tongue jack includes a tongue jack head housing operating components, a telescoping lifting foot cooperable with the tongue jack head and selectively displaceable via the operating components between an extended position and a retracted position, and an accessory hook coupled with the tongue jack head.

The tongue jack may further include a support pole connected between the tongue jack head and the telescoping lifting foot, wherein the accessory hook extends at an angle from a position adjacent a midpoint of the support pole to a position forward of the support pole. The accessory hook may alternatively extend at an angle from a position adjacent a midpoint of the support pole to a position aft of the support pole. The accessory hook may be secured in openings formed in the support pole. In this context, the tongue jack head may include notches therein adjacent the openings in the support pole.

The tongue jack head may include ridges in side surfaces thereof, where the accessory hook is secured in the ridges. The accessory hook may be snapped into the ridges.

In some embodiments, the accessory hook may be substantially U-shaped.

The tongue jack head may include a compartment on an underside thereof that is sized for receiving a power cord.

In another exemplary embodiment, a tongue jack includes a tongue jack head with ridges in two side surfaces thereof, and an accessory hook coupled with the ridges in the tongue jack head. The accessory hook extends from one of the two side surfaces, across an underside of the tongue jack head, to the other of the two side surfaces.

### BRIEF DESCRIPTION OF THE DRAWINGS

These and other aspects and advantages will be described in detail with reference to the accompanying drawings, in which:

FIG. 1 is a side view of a powered tongue jack incorporating an accessory hook;

FIG. 2 is a front view of the tongue jack head and accessory hook;

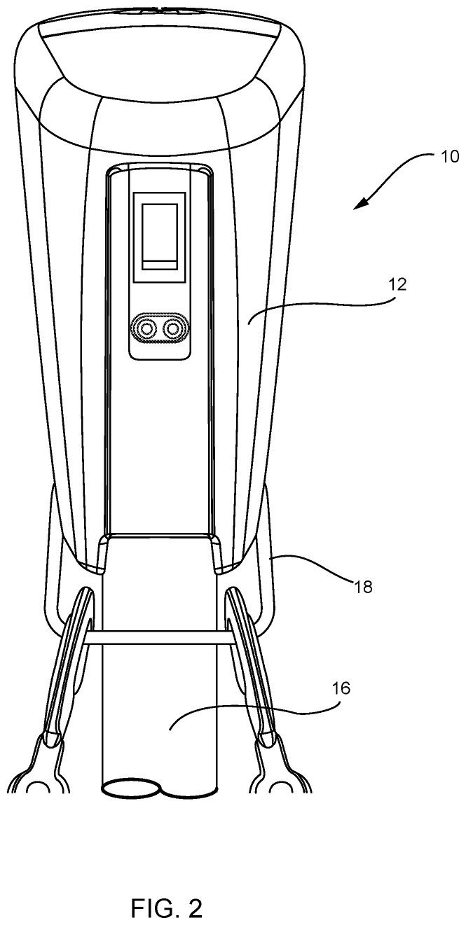

FIG. 3 is a lower perspective view of the tongue jack; and

FIG. 4 shows an embodiment with the accessory hook extending aft of the support pole.

### DETAILED DESCRIPTION

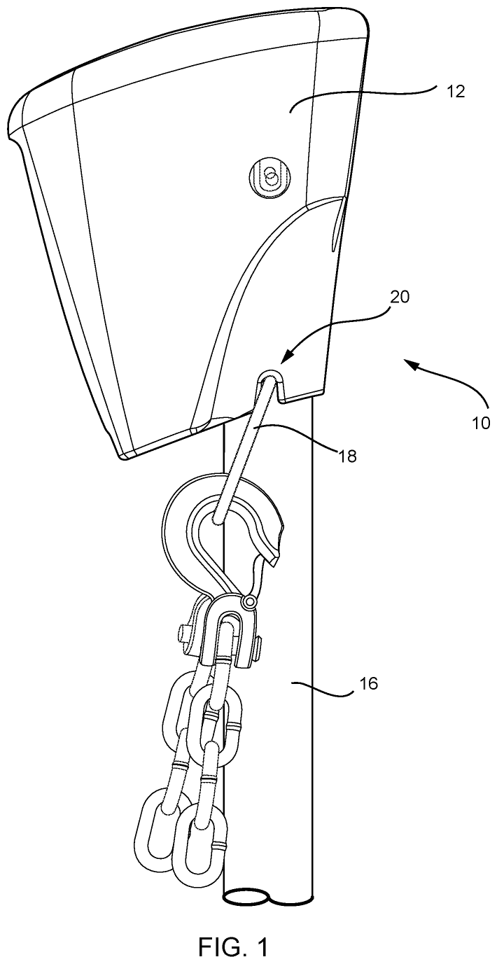

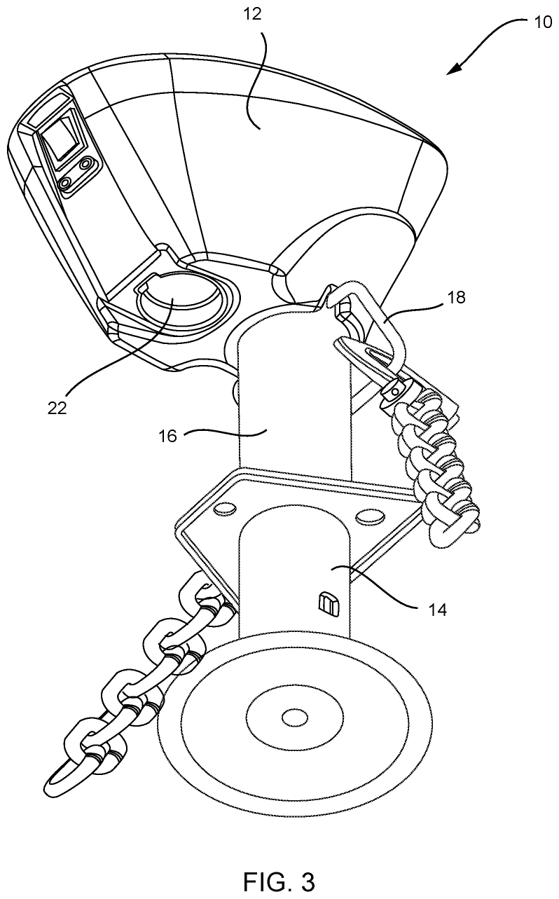

With reference to FIG. 1, a tongue jack 10 includes a tongue jack head 12 housing operating components. The operating components serve to displace a telescopic lifting foot 14 (FIG. 3) between an extended position and a retracted position. The function and operation of the operating components are known, and further details will not be described.

A support pole 16 is connected between the tongue jack head 12 and the telescopic lifting foot 14. The tongue jack head 12 is mounted on the support pole 16.

An accessory hook 18 is coupled with the tongue jack head 12. As shown, the accessory hook 18 may be substantially U-shaped. The accessory hook 18 is suited for supporting chains and electrical cords typically associated with a towable trailer.

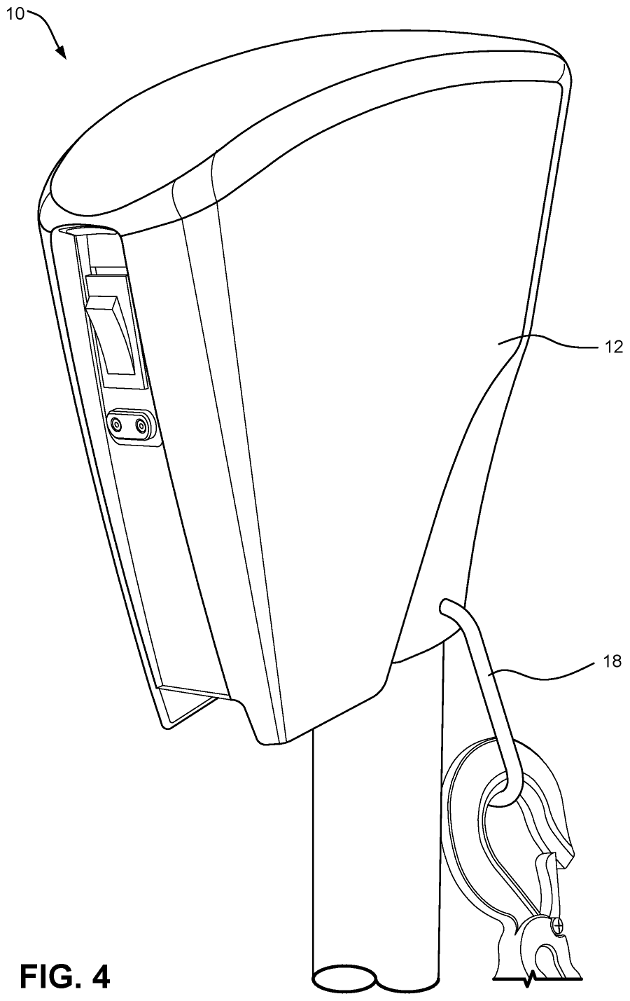

In some embodiments, the tongue jack head 12 is provided with ridges 20 in side surfaces thereof, where the accessory hook 18 is secured in the ridges 20. In some embodiments, the accessory hook 18 is pliable such that the hook 18 can be expanded over the ridges 20 and subsequently snapped in place. The accessory hook 18 can thus be oriented to extend at an angle forward of the support pole 16 (FIG. 1) or aft of the support pole 16 (FIG. 4). The accessory hook 18 may be connected adjacent a midpoint of the support pole 16.

In some embodiments, the accessory hook may be secured in openings formed in the support pole 16. In this context, the ridges 20 may take the form of notches in the tongue jack head 12 such that the accessory hook 18 essentially extends through both the tongue jack head 12 and the support pole 16. The accessory hook may alternatively be secured in openings formed in the support pole 16 below the tongue jack head 12.

The accessory hook 18 may be integrated into the tongue jack head 12. That is, the accessory hook 18 may be integrated with and permanently attached to the tongue jack head 12. In this variation, the accessory hook 18 may extend only into the tongue jack head 12. The accessory hook 18 is sized and shaped to avoid largely obstructing the user from interacting with the tongue jack when the accessory hook and/or the chains and cords are not needed.

In one construction, it is preferable for the accessory hook 18 to be positioned forward of the support pole 16 as shown in FIG. 1 to avoid the LP tanks/cover that could potentially be positioned behind the jack. FIGS. 3 and 4 show an alternative construction where the accessory hook 18 is positioned aft of the support pole 16. In either configuration, the accessory hook 18 extends from the side surface of the tongue jack head 12, across an underside of the tongue jack head, to an opposite side of the tongue jack head.

The tongue jack head 12 may also include a compartment 22 on an underside thereof that is sized for receiving a power cord or the like. See FIG. 3. In the embodiment shown, the compartment or housing 22 is located on the underside of the jack head 12 and forward of the support pole 16. In other embodiments, the compartment 22 could be located elsewhere on the jack head 12. The compartment 22 is generally shaped and sized to be approximate to the shape and size of a female connector of an RV power cord (not shown). In an exemplary embodiment, the compartment 22 has a diameter slightly larger than that of the female power cord connector to receive and contain the connector in a friction fit. In other embodiments, the compartment 22 may contain ridges, a retaining lip, or other retaining features such as a clip or latch.

In use, the compartment 22 contains and houses the connector end of a power cord to avoid damage from dragging on the ground or exposure to liquids, moisture, or other elements. In the embodiment shown, the compartment 22 is generally hidden from sight and therefore avoids largely obstructing the user from interacting with the tongue jack when the compartment and/or the chains and cords are not needed.

The accessory hook of the described embodiments is suited for supporting chains and electrical cords typically associated with the connection between a trailer and a tow vehicle.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A tongue jack comprising:
a tongue jack head housing operating components;
a telescoping lifting foot cooperable with the tongue jack head and selectively displaceable via the operating components between an extended position and a retracted position; and
an accessory hook coupled with the tongue jack head.

2. A tongue jack according to claim 1, further comprising a support pole connected between the tongue jack head and the telescoping lifting foot, wherein the accessory hook extends at an angle from a position adjacent a midpoint of the support pole to a position forward of the support pole.

3. A tongue jack according to claim 1, further comprising a support pole connected between the tongue jack head and the telescoping lifting foot, wherein the accessory hook extends at an angle from a position adjacent a midpoint of the support pole to a position aft of the support pole.

4. A tongue jack according to claim 1, further comprising a support pole connected between the tongue jack head and the telescoping lifting foot, wherein the accessory hook is secured in openings formed in the support pole.

5. A tongue jack according to claim 4, wherein the tongue jack head comprises notches therein adjacent the openings in the support pole.

6. A tongue jack head according to claim 1, wherein the tongue jack head comprises ridges in side surfaces thereof, and wherein the accessory hook is secured in the ridges.

7. A tongue jack head according to claim 6, wherein the accessory hook is snapped into the ridges.

8. A tongue jack according to claim 1, wherein the accessory hook is substantially U-shaped.

9. A tongue jack according to claim 1, wherein the tongue jack head comprises a compartment on an underside thereof that is sized for receiving a power cord.

10. A tongue jack comprising:
a tongue jack head including ridges in two side surfaces thereof; and
an accessory hook coupled with the ridges in the tongue jack head, the accessory hook extending from one of the two side surfaces, across an underside of the tongue jack head, to the other of the two side surfaces.

11. A tongue jack according to claim 10, wherein the accessory hook is angled forward relative to the tongue jack head.

12. A tongue jack according to claim 10, wherein the accessory hook is angled aft relative to the tongue jack head.

13. A tongue jack head according to claim 10, wherein the accessory hook is snapped into the ridges.

14. A tongue jack according to claim 10, wherein the accessory hook is substantially U-shaped.

15. A tongue jack according to claim 10, wherein the tongue jack head comprises a compartment on an underside thereof that is sized for receiving a power cord.
